(19) United States
(12) Patent Application Publication
(10) Pub. No.: US 2005/0080179 A1
(43) Pub. Date: Apr. 14, 2005

(54) Method for mixing coupled silica filled rubber

(76) Inventors: Kwang-Jea Kim, Fairlawn, OH (US); John P. VanderKooi, Akron, OH (US)

Correspondence Address: Ray L. Weber;Renner, Kenner, Greive, Bobak, Taylor & Weber, Fourth Floor, First National Tower, Akron, OH, 44308-1456, US

(21) Appl. No.: 10/684,737

(22) Filed: Oct. 14, 2003

(51) Int. Cl. C08L 1/00

(52) U.S. Cl. 524/445; 524/449; 524/451; 524/493; 524/494

(57) ABSTRACT

A method for mixing silicate mineral filled rubber wherein excess water is employed, either absorbed on the silicate mineral surface or added as an additional component in a mixing pass, yielding rubber compounds having lower alcohol content, lower Mooney viscosity, higher torque rise, less heat build-up, and better cure properties than achieved in rubber compounds made in a similar manner but without the added water.

### TECHNICAL FIELD

The present invention generally relates to silicate mineral filled rubbers. More particularly, this invention relates to a method for mixing coupled silicate mineral filled rubber, wherein benefits are realized as a result of employing water during a first pass mixing step.

### BACKGROUND OF THE INVENTION

Silicate mineral particles, particularly silica particles, are widely used as fillers in rubber compounds. But due to their polar and porous characteristics, silica mineral fillers are known to be more difficult to incorporate into rubber compounds than are other popular fillers, such as carbon black. The silicate mineral particles tend to form agglomerates that are difficult to break up and disperse, and poor dispersion generally results in undesirable properties in a silicate mineral filled rubber compound. Thus methods for improving the dispersion of silicate mineral fillers in rubber compounds are of great interest.

Perhaps the most common method for improving silicate mineral dispersion involves empolying silanes to chemically bind the silicate mineral fillers to the rubber matrix. The general process for this silane coupling requires mixing the silica mineral filler, silane and rubber in an internal mixer that serves to both disperse the filler and allow the silane a chance to react with the filler surface. The coupling reaction is a complicated hydrolysis reaction between the silane and naturally occurring water in the silicate mineral filler, and the reaction eliminates alcohol and produces a reactive silanol. This hydrolysis reaction occurs and is then followed by a condensation reaction wherein the silanol reacts with the silicate mineral surface to complete the coupling reaction. Excess temperature is detrimental to this process, because side reactions between the sulfur content in the silanes and the rubber matrix can take place. Also, alcohols may form from unreacted silane slowly reacting with moisture that is absorbed back in the rubber compound, and it is not uncommon for there to be an appreciable amount of residual alcohol in a final silicate mineral filled, silane coupled rubber compound. Mixing methods that provide better temperature control and reduce the potential for the formation of this residual alcohol would substantially improve upon the current state of the art.

In present preferred methods for incorporating silicate mineral fillers into rubber compounds, a three-pass mixing process is employed to produce a vulcanizable rubber compound. First, the rubber, silicate mineral filler, coupling agents, and other optional non cross-linking ingredients are mixed together, in a high shear mixer, to a temperature generally ranging from about 165 to about 180° C. After mixing in the first pass, the resultant mixture is cooled and other optional non cross-linking ingredients are added and further intimately mixed, this time to a temperature of from about 110 to about 160° C. The composition resulting from this second pass mix is cooled to below the vulcanization temperature of the vulcanizing agent that is to be added. The vulcanizing agent, typically sulfur and vulcanization accelerators, is then safely added, and intimately mixed at a non vulcanization temperature. The resultant vulcanizable rubber compound can be formed into sheets for later use in forming a desired end product.

This three-pass method is generally accepted as an industry standard, as it is believed that suitable dispersion of the silicate mineral filler must take place in two separate passes to allow for the appropriate filler coupling chemistry. Also, temperature is better controlled in the three pass method. The temperatures reached during the initial mixing pass may range above the thermal degradation temperature of the coupling agents that would be employed, especially if this first mixing step is to be carried out for a satisfactory amount of time to physically break up silicate mineral filler agglomerates. Furthermore, silanes, which are usually the coupling agents, generally contain sulfur, and mechanically mixing the rubber compound to a satisfactory extent may generate too much heat, and sulfur may evolve from the silane and initiate an undesired partial curing of the compound.

The three-pass method is necessarily more time and energy consuming than would be a two-pass method. Thus, in addition to the need for better temperature control and lower residual alcohol content, there is a need for a two-pass process for producing silicate mineral filled, coupled vulcanizable rubber compounds that does not suffer from the very drawbacks that currently prevent two-pass methods from being widely employed.

### SUMMARY OF THE INVENTION

This invention generally provides a method for mixing silicate mineral filled rubber comprising the steps of adding a polymer base, silicate mineral filler, water, and silicate mineral coupling agent to a mixer to create a first pass mixture, wherein the silicate mineral to water weight ratio is from 1:4 to 10:1; and mixing the first pass mixture to a target temperature suitable for initiating coupling of the silicate mineral filler to the polymer base. Generally the target temperature will range from 120 to 200° C. Also provided is a silicate mineral filled rubber compound made in accordance with this process. In a paricular embodiment, the water treated silicate mineral filler has a silicate mineral to water weight ratio of from 1:3 to 5:1, and, in yet another embodiment, from 1:2 to 4:1.

Due to the presence of an excess amount of water on the silicate mineral surface, the hydrolysis reaction mechanism involved in coupling silicate mineral filler to the polymer base is facilitated. Additionally, the temperature rise rate during shear mixing is lower than that experienced in moisture starved systems, because the heat being generated by the mixing forces is carried from the system by evolving vapor. As a result, longer mixing times are possible before the mixing step must be paused for a cooling step. The water that is boiled off also carries residual alcohol from the rubber compound, and a silicate mineral filled, coupled rubber compound made in accordance with this process will have a lower alcohol content than a compound made in a moisture starved system.

In another embodiment of this invention, a water treated silicate mineral filler is provided comprising a silicate mineral filler and water, wherein the silicate mineral filler to water weight ratio is from 1:4 to 10:1. This filler may be prepared by the absorption of water onto the silicate mineral surface. This silicate mineral filler is particularly useful in the present process.

### BRIEF DESCRIPTION OF THE DRAWINGS

FIG. 1 is a general reaction schematic showing the hydrolysis and condensation reactions occurring during silane coupling to a silica surface;

FIG. 2 is a reaction scheme showing the coupling of a trialkoxysilane to a silica surface;

FIG. 3 is a graph representing the heat generated during the first pass mixing of control and experimental compounds;

FIG. 4 is a graph comparing a probe temperature at the end of a first pass mixing step as compared to a predetermined set drop temperature programmed into and read by the mixer employed;

FIG. 5 is a graph of Mooney viscosity (ML (1+4)) of the control and experimental compounds;

FIG. 6 provides cure curves for the control and experimental compounds, measured at 160° C. for 30 minutes;

FIG. 7 provides scorch time (Ts-2) and cure times (Tc-90) for the control and experimental compounds, measured at 160° C.;

FIG. 8 provides the torque rise (M_{H}-M_{L}) of the control and experimental compounds, measured at 160° C.;

FIG. 9 provides the modulus change as a function of storage time, at 300% elongation, for the control and experimental compounds;

FIG. 10 represents heat buildup (HBU) for the control and experimental compounds;

FIG. 11 provides blowout (BO) times for the control and experimental compounds;

FIG. 12 provides viscoelastic properties of the control and experimental compounds;

FIG. 13 provides the alcohol weight percent per silane remaining in the experimental and control compounds after mixing; and

FIG. 14 represents the mixing time and weight loss for the control and experimental compounds.

### DETAILED DESCRIPTION OF THE PREFERRED EMBODIMENT

In accordance with the preferred embodiment of the present process, a two pass mixing process is employed to produce a vulcanizable rubber compound that includes silicate mineral fillers coupled to the polymer base matrix. But it is to be noted that this process is not limited to such a preferred embodiment inasmuch as benefits resulting from the practice thereof are not necessarily limited to two pass mixing processes, and those of ordinary skill in the relevant arts will readily appreciate this fact. For instance, the present invention may be practiced in processes employing three or more passes, or might be employed to create a rubber compound that is not vulcanizable (i.e., without curing agents and accelerators). The benefits of this process result from either treating the silicate mineral filler with water before its incorporation into the polymer base compound or adding excess water to the first pass mixture.

According to a preferred embodiment of the invention, the non cross-linking ingredients needed to provide the rubber composition with the necessary mechanical and workability characteristics are added to and incorporated into the polymer base during the first mixing step. To produce a vulcanizable rubber compound, a polymer base, silicate mineral filler, water (either as a separate addition or treated/absorbed on the filler or both), and silicate mineral coupling agent are added to a mixer to create a first pass mixture. Other optionally ingredients, such as activators, processing aids, plasticizers and anti-ozonants may be included in the first pass mixture. In a particularly preferred embodiment, the polymer base is first added to the mixer and mixed for about 30 to 60 second, at which time all other non cross-linkning ingredients are added. The mixture is then further mixed, with evolving steam being vented as needed.

The first pass mixture is mixed to a target temperature, and then dropped and cooled. To this first pass mix is then added sulfur and cure accelerators to form a second pass mixture. The second pass mixture is mixed to a target temperature and then dropped, formed and cooled for later use.

Among the polymer bases useful for the purposes of the invention, unsaturated chain polymers or copolymers obtained by polymerization of conjugated dienes and/or aliphatic or aromatic vinyl monomers are preferred. More particularly, the polymer bases object of the invention may be selected from the group comprising: natural rubber, 1,4-cis polybutadiene, polychloroprene, 1,4-cis polyisoprene, optionally halogenated isoprene-isobutene copolymers, butadiene-acrylonitrile, styrene-butadiene and styrene-butadiene-isoprene terpolymers, either prepared in solution or in emulsion, ethylene-propylene-diene terpolymers. Mixtures of the forgoing may also be used, according to the desired characteristics of the finished product.

Silicate mineral fillers are well known, and may include clays, such as bentonite and kaolin, mica, talc, glass fiber, various silicates, and especially silica, which is perhaps the most widely used. While it should be appreciated that any silicate mineral filler may be beneficially incorporated into a rubber matrix in accordance with this invention, the silica fillers are focused upon herein, in the preferred embodiment.

The silica filler is preferably a particulate silica having a BET surface area of between 100 and 300 m²/g and preferably a BET surface area of between 130 and 220 m²/g, a CTAB surface area of between 100 and 250 m²/g, and preferably a CTAB surface area of between 150 and 200 m²/g, an oil absorption measured in DBP of between 150 and 250 ml/100 g. The particulate silica selected may be used alone or in the presence of other fillers, such as carbon black or another conventional silica, that is to say, one not having all of the characteristics indicated above.

The silicate mineral is typically incorporated into the vulcanizable rubber composition at about 10 to 100 parts by weight of silicate mineral for each 100 parts by weight of polymer base, more typically at from 10 to 80 parts by weight.

It is well known that silicate mineral fillers, particularly silica fillers, usually have a small moisture content, in the range of from about 4 to 7 weight percent (4-7wt %) water. The benefits of further treating the silicate mineral to increase its water content have, however, not been appreciated in the prior art. In the process of this invention, the silicate mineral is first treated with water before being used in the first pass mixture. The water treated silicate mineral filler preferably has a silicate mineral to water weight ratio of from 1:4 to 10:1; more preferably from 1:3 to 5:1; and, in a particularly preferred embodiment, from 1:2 to 4:1.

Useful silicate mineral coupling agents are generally known in the art, and this invention is not to be limited to any particular class or type of such coupling agent. The silicate mineral coupling agents are generally know, and preferred groups include silanes, titanates, and zirconates. Silanes are particularly preferred, and are the focus of the preferred embodiment.

Particularly suitable silane coupling agents include bis(3-triethoxysilyl-propyl)tetrasulfide (TESPT), bis(3-triethoxysilyl-propyl)disulfide (TESPD), bis(2-triethoxysilyl-ethyl)tetrasulfide, bis(3-trimethoxysilyl-propyl)tetrasulfide, bis(2-trimethoxysilyl-ethyl)tetrasulfide, 3-mercaptopropyl-trimethoxysilane, 3-mercaptopropyl-triethoxysilane, 2-mercaptoethyl-trimethoxysilane, 2-mercaptoethyl-triethoxysilane, 3-nitropropyl-trimethoxysilane, 3-nitropropyl-triethoxysilane, 3-chloropropyl-trimethoxysilane, 3-chloropropyl-triethoxysilane, 2-chloroethyl-trimethoxysilane, 2-chloroethyl-triethoxysilane, 3-trimethoxysilylpropyl-N,N-dimethylthiocarbamoyl tetrasufide, 3-triethoxysilIylpropyl-N,N-dimethylthiocarbamoyl tetrasulfide, 2-triethoxysilyl-N,N-dimethylthiocarbamoyl tetrasulfide, 3-trimethoxtsilylpropyl-benzothiazole tetrasulfide, 3-triethoxysilylpropyl-benzothiazole tetrasulfide, 3-triethoxysilylpropyl-methacrylate monosulfide, 3-trimethoxysilylpropyl-methacrilate monosulfide, and the like.

Particularly preferred are TESPD and TESPT.

For the purposes of this invention, and independently from the method chosen to add the silicate mineral (separately, in one or several steps, or at least partly with the coupling agent), the silicate mineral coupling agent is added to the rubber composition in a quantity of from 1 to 30 parts by weight per each 100 parts by weight of the silicate mineral and preferably between 2 and 20 parts by weight per each 100 parts by weight of the silicate mineral. In a particularly preferred embodiment, 3 to 15 parts by weight silicate mineral coupling agent is employed per each 100 parts by weight silicate mineral. The coupling agent is typically added as a liquid through direct injection, and could also be included on a filler or encapsulated in an organic binder.

The mixer for the first pass mixing step may be selected from high shear mixers that would be appreciated as suitable for mixing the ingredients, and particularly useful mixers are selected from Banbury mixers, mill mixers, and continuous internal mixers. As the first pass mixture is mixed, the temperature of the mixture increases due to shear forces, but at a slower rate than what would be observed if only the minor amount of water typically present in untreated silicate mineral were present. The temperature rise is slowed by the latent heat of vaporization of the excess water with which the silicate mineral is treated. The water absorbs the generated heat and boils, effectively removing that heat from the remaining ingredients. As the water boils off, it also carries alcohol out of the system. Thus, the mixer is to have an exhaust for removing water vapor and alcohol from the system. Typically, the mixers include heat exchange elements to aid in heat removal, and it will be appreciated that the present process demands less work/energy consumption by such elements, as a result of the slow rise in temperature resulting from the water evaporation and the endothermic condensation reaction.

The first pass mixture is preferably mixed until a target temperature is reached, at which time the first pass mixture is dropped from the mixer and cooled. The target temperature may be selected based upon the understanding that the temperature should be sufficient to complete the hydrolysis reaction and initiate the silanol to filler coupling reaction. Generally, the fist pass mixture will be dropped at a temperature between about 120 and 200° C.; preferably at between 130 and 190° C.; and, in a particularly preferred embodiment, at between 140 and 180° C. In accordance with this invention, the time taken will be substantially longer than that required in processes not employing water (as a filler treatment or mixture addition or both) as taught herein.

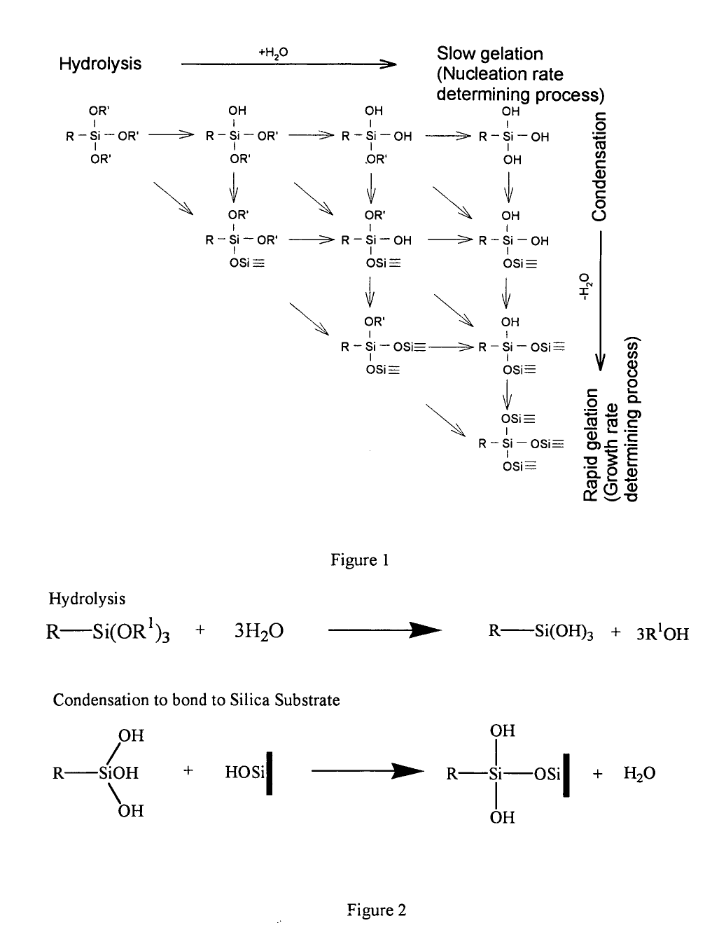

As the first pass mixture is mixed, the silane alkoxy groups are able to react with the surface groups of the silicate mineral fillers. A reaction scheme is shown in FIGS. 1 and 2, wherein R′ is to generally represent an alkoxy group, and R a reactive component capable of interacting with a chosen polymer base (the polymer base does not appear in the reaction schemes). The alkoxy groups first react with water to produce a silane mono, di, or triol, releasing alcohol as a byproduct. The silanol groups produced in this hydrolysis reaction, then condense with oxide or hydroxyl groups on the filler surface, binding the silane and the silicate mineral. The remaining reactive component (R) binds to the polymer base through chemical reaction, such as grafting, addition, or substitution, with active groups on the polymer. These reactive groups are thus chosen to be compatible with the polymer base.

Because the silicate mineral is treated with excess water, the hydrolysis reaction is driven, increasing the rate of silanol production and thereby ensuring that there will be less alcohol formation in downstream processes. During the mixing, substantially all of the water is evaporated, and the water vapor carries away evolved alcohol, decreasing the alcohol content of the mix, and further facilitating hydrolysis, because alcohols tend to reverse the hydrolysis reaction and stabilize the solution.

The hydrolysis and condensation reaction kinetics may also be controlled acid and base catalysis. Acids may be added to increase the rate of hydrolysis, and bases may be added to increase the rate of condensation. With reference to FIG. 1, base catalyzed hydrolysis favors the substitution of the —(OSi)₃ group (bottom right) for the alkoxy group (—(OR)₃) (top left) and acid catalyzed hydrolysis favors the substitution of a hydroxy (—(OH)₃) group (top right) for the alkoxy group (—(OR)₃) (top left). The rate of acid hydrolysis is significantly greater than base hydrolysis and is minimally affected by other carbon-bond substituents. Hydrolysis and condensation reactions are affected by the pH level of the solution. The slowest rate of hydrolysis occurs at approximately neutral pH. Each change of pH by 1 pH unit leads to approximately a 10-fold change in the hydrolysis rate. Condensation reaction is also controlled by pH with a minimum at pH 4. Thus, acids may be added to increase hydrolysis, and, compounding bases, such as ZnO and 6PPD, can be added to neutralize the acid, after a vent stage, once a significant amount of hydrolysis has ocurred, and the base will help drive condensation.

Once the first pass mixture is dropped and cooled, a sulfur cure package is added to form a second pass mixture. The sulfur cure package includes sulfur and sulfur cure accelerators, such as, but not limited to DPG and TBBS. The second pass mixture is then mixed to incorporate the vulcanizing agents and produce the vulcanizable rubber compound end product that is the focus of this preferred embodiment of the present process. In a particularly preferred process, from about 40 to 60% of the first pass mixture is added to the second pass mixer and premixed for about 30 to 60 seconds, at which time the cure package is added along with the remaining 40 to 60% of the first pass mixture.

The mixer for the second pass mixing step may be selected from the same mixers that are suitable for the first pass mixing, and should be selected according to its ability to incorporate the vulcanizing agents into the ingredients. As the second pass mixture is mixed, the temperature of the mixture increases due to shear forces, and the second pass mixture is preferably dropped at a target temperature. The target temperature may be selected based upon the properties of the cure system, particularly, the temperature should be selected to avoid initiating curing of the rubber compound.

The resulting vulcanizable rubber compound is characterized by having a lower alcohol content, lower Mooney viscosity, higher torque rise (M_{H}-M_{L}), less heat build up (HBU), and better cure properties than would be experienced in vulcanizable rubber compound made in the same manner but with silicate mineral that is not water treated.

### Experimental

In the experiment below, multiple experimental batches of silica-filled elastomer compounds were prepared and their properties compared against a Control silica-filled elastomer. The control is identified by the term “Control” in the Tables and in discussions below, while the various experimental batches are identified by “Batch” numbers, e.g., “Batch 1,” “Batch 2,” etc.

Materials

The silane used in this study was (triethoxysilylpropyl)disulfide (TESPD) with carbon black carrier (50% CB), trade name SCA985CB (Struktol, USA).

The elastomer used was a styrene-styrene butadiene rubber (S-SBR, 35% styrene), brand name Duradene 753 (Firestone, USA).

The silica used was a precipitated amorphous silica with BET area 145-180 (m²/g), Rhodia ZS 1165 MP (Rhodia, USA). For experimental Batches, the silica particles were treated with distilled water (H₂O) at 50wt % H₂0 per 100wt % silica. The moisture level of the untreated silica was 5.0 wt %.

The carbon black used was a furnace amorphous black, N339 (Harwick, USA).

Various additives including activators (ZnO, stearic acid), processing aid (Sunolite240, Witco, USA), plasticizer (Sundex 790, Sun Company, USA), anti-ozonant (6PPD, Struktol, USA), curing agent (Rubbermakers Sulfur, R. E. Carroll, USA), and accelerators (TBBS, DPG) were used for producing a tire tread compound.

Mixing

According to the procedure used, the Control and the experimental Batches were compounded in a two-pass process. First, a Banbury internal mixer (BR 1600, Farrel, USA) was used for a first pass masterbatch mixing of the rubber and additives. The ingredients and amounts mixed in this first pass are shown in Table 1. The drop temperature for each compound is also provided in Table 1. The ingredients and ingredient amounts are the same for every experimental batch, except that the Control includes 20 parts by weight less water because it includes untreated silica. The the main variable across the experimental Batches produced in the first pass is the drop temperature.

TABLE 1
First Mixing Pass

| | Control | Batch 1 | Batch 2 | Batch 3 | Batch 4 |
|---|---|---|---|---|---|
| Material | (120° C.) | (120° C.) | (140° C.) | (160° C.) | (176° C.) |
| SBR | 120.0 | 120.0 | 120.0 | 120.0 | 120.0 |
| CB | 40.0 | 40.0 | 40.0 | 40.0 | 40.0 |
| ZS | 38.0 | 38.0 | 38.0 | 38.0 | 38.0 |
| H₂O | 2.0 | 22.0 | 22.0 | 22.0 | 22.0 |
| ZnO | 3.0 | 3.0 | 3.0 | 3.0 | 3.0 |
| StAc | 1.5 | 1.5 | 1.5 | 1.5 | 1.5 |
| Sun240 | 1.0 | 1.0 | 1.0 | 1.0 | 1.0 |
| Sun790 | 23.0 | 23.0 | 23.0 | 23.0 | 23.0 |
| 6PPD | 2.0 | 2.0 | 2.0 | 2.0 | 2.0 |
| SCA985CB | 6.4 | 6.4 | 6.4 | 6.4 | 6.4 |

In the first pass, the mixer operated at 100 RPM and 30 psi. The SBR rubber was added and mixed for 30 seconds. Thereafter, the remainder of the additives identified in Table 1 were added and mixed for an additional 120 seconds, sweeping at every 60 seconds. The first pass Batches (and Control) were dropped at the temperatures indicated.

In the second pass, sulfur and other accelerators (TBBS, DPG) were added and compounded with mixture from the first pass. The ingredients and amounts mixed in the second pass are shown in Table 2, and identical portions of the respective first pass mixture are employed across the Control and experimental Batches. The fill factor, RAM pressure and rotor speed were fixed at 70%, 30 PSI and 77 RPM, respectively. First, halfofresultant mixture from the first pass was added and mixed for 30 seconds. Next, the second half of the first pass mixture was added along with the sulfur and accelerators, and the batches were further mixed, for 2 minutes or until the batch temperature reached 93 C, at which point the batches were dropped, cooled, and tested.

TABLE 2
Second Mixing Pass

| | Control | Batch 1 | Batch 2 | Batch 3 | Batch 4 |
|---|---|---|---|---|---|
| Material | (120° C.) | (120° C.) | (140° C.) | (160° C.) | (176° C.) |
| From First | 236.9 | 239.9 0 | 239.9 | 239.9 | 239.9 |
| Pass Mix | | | | | |
| S | 1.4 | 1.4 | 1.4 | 1.4 | 1.4 |
| TBBS | 1.7 | 1.7 | 1.7 | 1.7 | 1.7 |
| DPG | 0.2 | 0.2 | 0.2 | 0.2 | 0.2 |

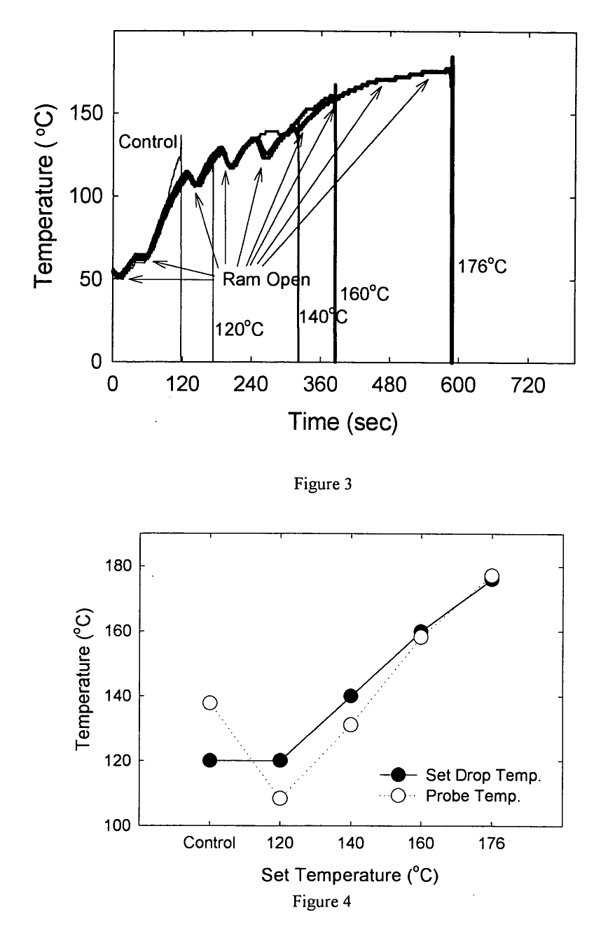

FIG. 3 represents the heat generation during internal mixer processing at different drop temperatures. It will be appreciated that the addition of excess water according to this invention reduced the temperature rise during mixing. As the drop temperature increased, the mixing time increased. The temperature rise between 160° C. and 176° C. was longer than other compounds.

In the first pass mixing step (see Table 1), the Control and experimental Batches were to be dropped at predetermined temperatures. The Banbury mixer employed has a control that reads the temperature at the wall of the mixer, and drops the mixture when the temperature reading reaches a programmed value. However, the actual temperature of the mixture might be different than that read by the mixer, and a probe was employed to read the actual temperature of each mixture at the time they were dropped. FIG. 4 shows the probe temperature of the compounds after master batch first pass mixing as compared to the set drop temperature programmed into and read by the mixer. The probe temperature of the Control showed higher than the set drop temperature; however, a majority of the moisture treated compounds exhibited lower probe temperatures than the set drop temperature, although, as the drop temperature increased the temperature differences (between the probe temperature and the set drop temperature) became closer. The probe temperature was higher than the set drop temperature for Batch 4, which was targeted for dropping at 176 C.

Mooney Viscosity Measurement

Mooney viscosities were measured as a function of apparent shear rate at 2 RPM and ML1+4 at 100° C. according to ASTM D1646. The rotor diameter of the shearing disc rheometer was 38.1 mm and the thickness of the rotor was 5.5 mm. A Mooney Viscometer 2000 (MV 2000, Alpha Technologies, USA) was used to measure Mooney viscosity. The shear rate at the outer radius of the shearing disc is expressed according to the following equation (1):

$$γ ( R ) = \frac{R Ω}{H} \qquad ( 1 )$$

where R is the radius of the rotating disc, Ω is the rotor rotation rate, and H is the distance between the disc surface and the stationary housing.

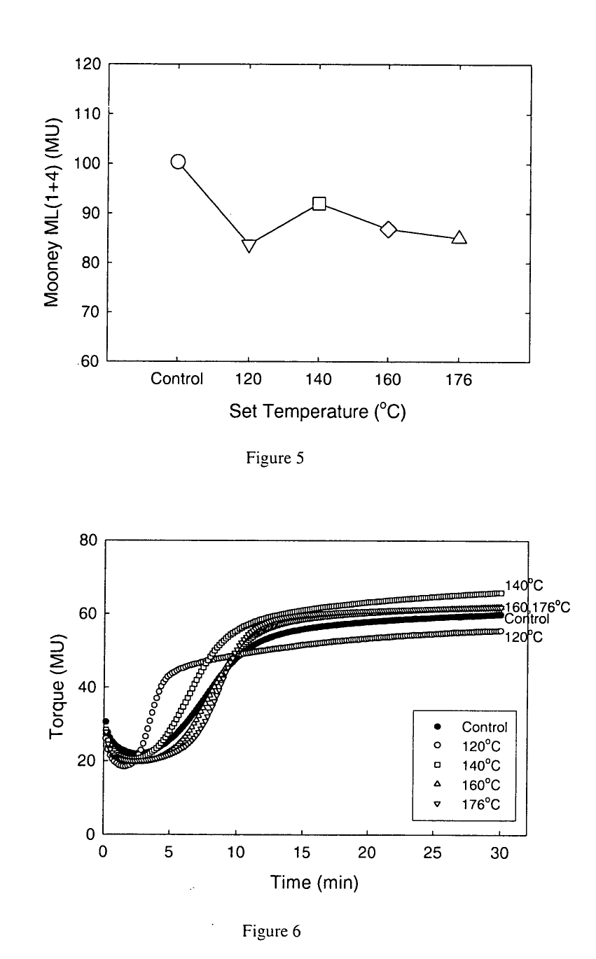

FIG. 5 represents moisture effects on Mooney viscosity at 0.2 rad/sec and 100° C. The addition of moisture lowered the viscosity of the SBR compounds, which was the same order observed from the cure rheometer M_{L} torque data shown.

The excessive moisture coated silica acted as a lubricant in the SBR compounds during mixing.

Cure Rheometer Test

An oscillating disc cure rheometer (Rheotec, Tech Pro Inc., Ohio) was used to measure vulcanization and reversion resistance properties of the compounds in accordance with ASTM D 2084 at 160° C. The oscillation frequency was 100 cycles/min (1.66 Hz) with an amplitude of 3°. Minimum torque (M_{L}), maximum torque (M_{H}), torque rise (M_{H}-M_{L}), scorch time (Ts-2), cure time (Tc-90), and reversion resistance time (T-2) were measured.

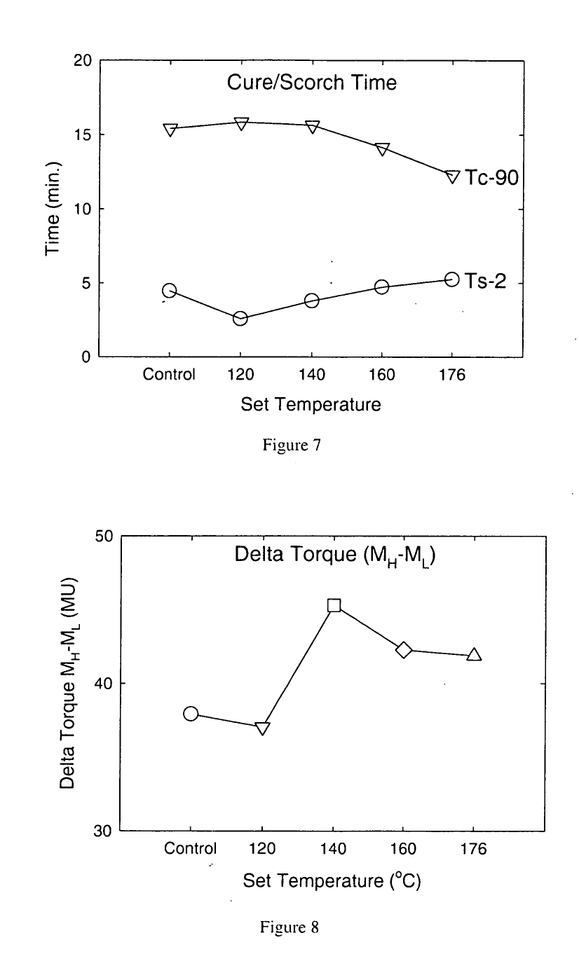

FIG. 6 shows the vulcanization curve of the Control and experimental Batches at 160° C. for 30 min. All compounds did not exhibit reversion behavior (T-2), rather they exhibited slightly marching behavior. Moisture added compounds exhibited lower torque (M_{L}) than the Control (see FIG. 4). The Control compound exhibited higher low torque (M_{L}) and lower high torque (M_{H}) than other compounds except for Batch 1 (120° C.). With reference to FIG. 7, as the drop temperature increased, the scorch time (Ts-2) increased; however, the cure time (Tc-90) decreased. Referring now to FIG. 8, the moisture treated experimental Batches showed higher delta torque (M_{H}-M_{L}) than the Control. Among them Batch 2 (140° C.) compound showed the highest torque rise.

The above results show that the addition of moisture changed the cure curve characteristics and increased the degree of cross-linking in the compounds. The moisture level and dump temperature should be considered as an important factor in the tire compounds.

Tensile Test

An Instron tensile tester (Model 4201, Instron, USA) including a data acquisition system was used to obtain tensile test data. Dumbbell specimens were used, and the average values for three specimens were calculated for the Control and each experimental Batch, following ASTM D 412-87. The modulus (Pa) of each compound was measured at 300% elongation. The thickness and the width of the specimens averaged 2.2 mm and 6.3 mm, respectively.

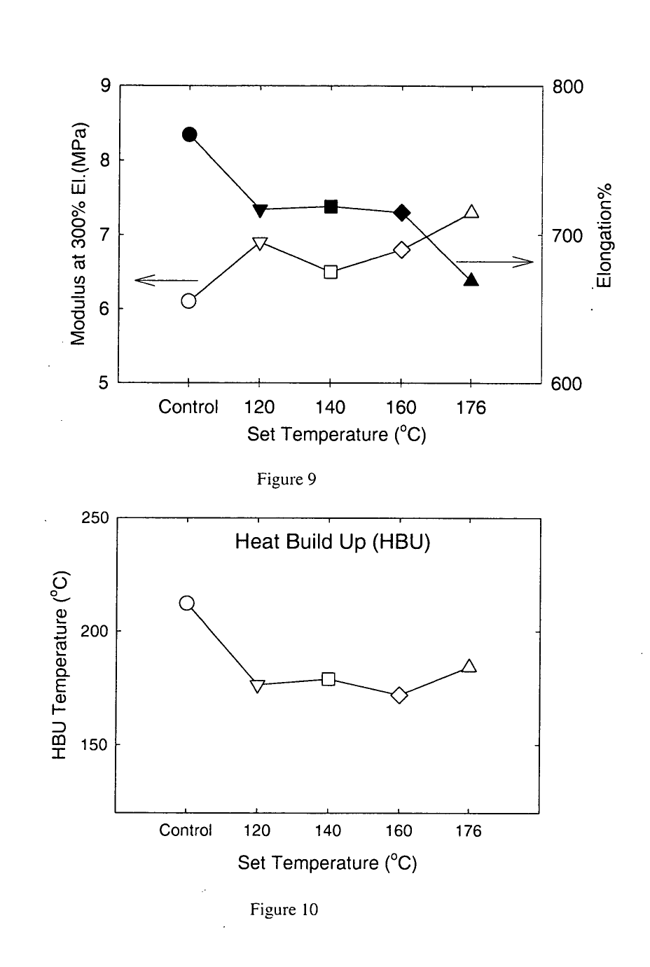

FIG. 9 represents modulus change as a function of storage time at 300% elongation. The values therein were measured from dumbbell shaped specimens according to the method in ASTM D 412-87. The moisture treated compounds of Batches 1-4 exhibited higher elongation modulus than the Control. As the drop temperature increased the modulus of moisture treated compounds increased between Batch 2 to Batch 4, and, as the drop temperature increased the elongation % decreased.

Heat Build Up (HBU) and Blowout (BO) Test

HBU and BO tests were carried out using the “Firestone Flexometer”(Firestone, USA) per ASTM D 623. This testing apparatus was used to apply a uniform circulatory oscillating action to each compound specimen under compression. The test specimen is positioned between the fixed upper part and the moving bottom part. The bottom part oscillated at a constant speed of 787 RPM. The amplitude of the lower moving part was 7.6 mm. The compression pressure applied was 0.8 MPa under the HBU test and 1.7 MPa under the BO test. The test specimen was in the shape of a frustum of a rectangular pyramid with dimensions; base, 54.0 by 28.6 mm; top, 50.8 by 25.4 mm; and altitude, 38.1 mm. For the HBU test, the inside temperature of the specimen was measured after 45 minutes. After completion of the BO test, the dimension at the center part of the sample length was measured and the deformation ratio (%) was calculated.

FIG. 10 represents heat build up (HBU) for the Control and experimental Batches. As compared to the Control, the moisture treated compounds of all Batches 1-4 showed lower heat generation under compressive circular oscillatory shear stress. Among the different drop temperature compounds of Batches 1-4, there were no significant differences in temperature build up.

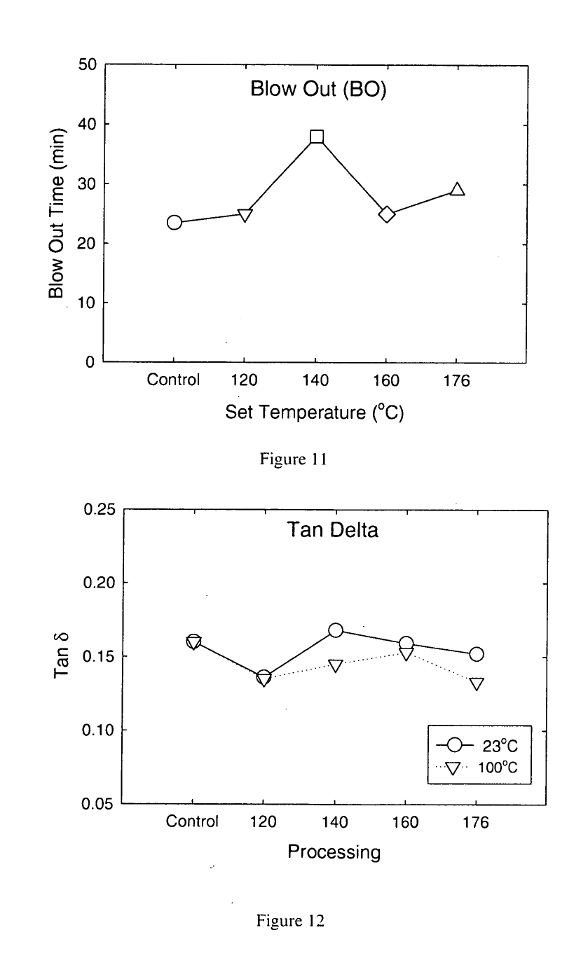

FIG. 11 shows blow out (BO) time for the Control and experimental Batches. The treatment of moisture on silica surface exhibited improved BO time for only Batch 2, the 140° C.-drop batch.

Viscoelastic Property (tan δ) Measurement

Vulcanized specimens were characterized using a Mechanical Energy Resolver (MER-1100B, Instrumentors, Inc., USA). This instrument measured oscillatory input of axial compression and tension response of a cylindrical specimen. Oscillatory signal responses of each material were measured and recorded as the elastic and the viscous property as follow:
tan δ=G″/G′ (3.1)
G′(ω)=G*cos δ (3.2)
G″(ω)=G*sin δ (3.3)
η′(ω)=ωG″=G*sin δ (3.4)
where ω represents oscillation frequency; G*, the modulus; δ, the phase angle; G′(ω), the storage modulus; G″(ω), the loss modulus; and η′(ω), the dynamic viscosity.

The diameter and the length of the cylindrical specimens averaged 17.5 mm and 25.5 mm, respectively.

FIG. 12 shows viscoelastic properties (tan6) measured from the MER at both 23 C and 100 C. It can be seen that the moisture treated compounds of Batches 1-4 exhibited tan δ values equal to or lower than the Control. The tan δ values at 100° C. were generally lower than those at 23° C. for the experimental Batches 1-4.

Alcohol Contents

Quantitative determination of the ethanol content within the final resultant compounds was based upon measurements of the concentration of ethoxy silane (EtOSi) left unreacted in the uncured stocks. The (EtOSi) in the stock was found by treating a sample with a siloxane hydrolysis reagent composed of 0.2 N toluenesulfonic acid /0.24 N water/15% n-butanol/85% toluene. This reagent quantitatively reacts with residual (EtOSi) freeing a stoichiometric amount of ethanol that is then measured by a headspace/gas chromatographic technique. Alcohol residues remaining in the compounds were analyzed by Bridgestone-Firestone R&D, Inc. (Akron, Ohio).

FIG. 13 represents the alcohol weight percent per silane remaining in the compound after mixing. The moisture treated compounds of Batches 1-4 showed less alcohol residues compared to the untreated Control. As the drop temperature increased (from Batch 1 to Batch 4), the alcohol content remaining in the compound decreased. Batch 4, dropped at 176° C., showed the lowest level of alcohol in the compound.

Mixing Times and Weight Loss During Mixing

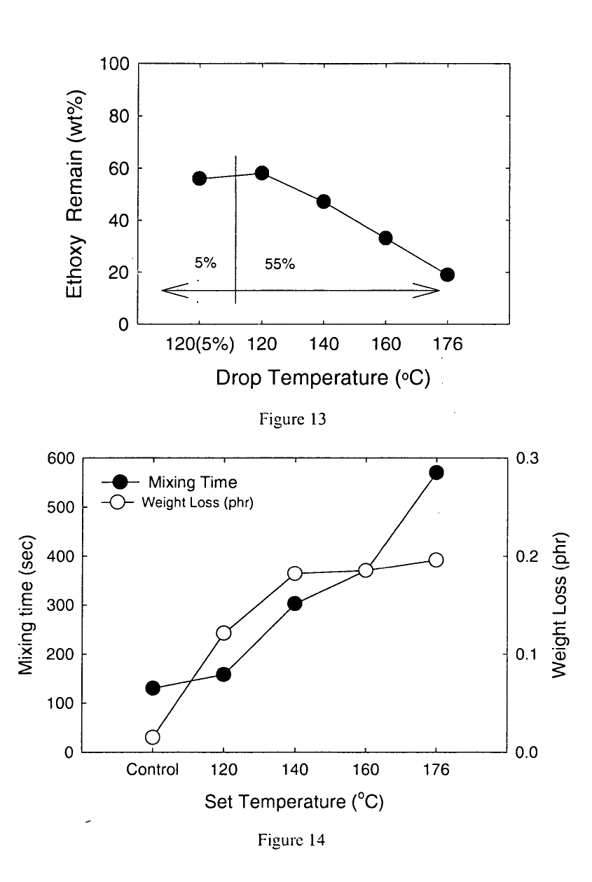

FIG. 14 represents the mixing time and the weight loss for the Control and Batch compounds. Water evaporation during mixing mainly contributed to the loss of weight in the first pass mixing of the experimental Batches. The mixing time and the weight loss of each Batch increased as the set drop temperature increased. While the weight loss for Batches 2, 3, and 4 did not change significantly, the mixing time for Batch 4 increased significantly (See FIG. 3).

Oven Aging

Batch 4, dropped at 176° C., showed the least amount of bubble formation during air curing. Batch 1, dropped at 120° C., showed many small bubbles. As drop temperature increased, bubble formation appeared to decrease. Thus, particularly above 120° C., most of the volatiles that might casues bubbles to form during processing and curing are driven off.

Moisture treated silica fillers yielded improved physical properties, and Batch 4, the 176° C. drop compound, showed the most improved physical properties, with less bubble formation. In addition, it showed the lowest alcohol content after mixing. This indicates that the moisture abundant silica accelerated the hydrolysis reaction of the silane. It is generally appreciated that unreacted alkoxy groups remain in silane due to steric hindrance; however, this experiment showed that alkoxy is further hydrolyzed with the excess water molecule on silica surface. Batch 4 showed longer mixing time and lower temperature rise rate than other compounds, as shown in FIG. 3. This indicates that the latent heat of vaporization of the water played a significant role in slowing down stock temperature rise. Furthermore, the condensation reaction between the hydroxyl group on the silica surface and the hydroxyl group on silane reacted effectively. The condensation reaction consumes the viscous heat generated during mixing, which results in lower temperature rise rate in the mixer because the condensation reaction is endothermic.

As shown in FIG. 3, the Control showed the highest temperature rise rate, and the moisture treated compounds showed lower temperature rise rates. The vaporization energy of water maintained the stock temperature rise rate low and prevented the compounds from over heating, which causes pre-scorching during mixing. In this experiment, as the drop temperature was increased, Ts-2 and Tc-50 increased, and Tc-90 reduced. This maybe due to the reduced level of moisture and alcohol in the compounds at the high temperature drop.

Batch 1, dropped at 120° C., showed lower physical properties. This may be due to lower temperature of the stock for hydrolysis reaction during mixing. As shown on probe temperature, the actual temperature of the stock was about 110° C. even though it was set to drop at 120° C., which is a low temperature for hydrolysis reaction during short mixing time.

In general, the moisture treated silica compounds showed improved mechanical properties, lower heat generation during mixing, and fast cure characteristics. As the drop temperature increased, the physical property increased, and less alcohol remained in the compounds. At the vulcanization stage, fast cures were realized, and a strong 3-dimensional network structure was formed, as the degree of cross-linking was increased by the presence of water.

In light of the foregoing, it should thus be evident that the process of the present invention, providing an improved method for mixing silica filled rubber, substantially improves the art. While, in accordance with the patent statutes, only the preferred embodiments of the present invention have been described in detail hereinabove, this invention is not to be limited thereto or thereby. Rather, the scope of the invention shall include all modifications and variations that fall within the scope of the attached claims.

1. A method for mixing silica filled rubber comprising the steps of:
adding a polymer base, silicate mineral filler, water, and silicate mineral coupling agent to a mixer to create a first mixture, wherein the silicate mineral filler to water weight ratio is from 1:4 to 10:1; and
mixing the first mixture to a target temperature suitable for initiating coupling of the silicate mineral filler to the polymer base.

2. The method of claim 1, wherein the silicate mineral filler to water weight ratio is from 1:3 to 5:1.

3. The method of claim 1, wherein the silicate mineral filler to water weight ratio is from 1:2 to 4:1.

4. The method of claim 1, wherein the first mixture includes from about 10 to 100 parts by weight of silicate mineral filler per 100 parts by weight of the polymer base.

5. The method of claim 1, wherein the first mixture includes from about 1 to 30 parts by weight silicate mineral coupling agent per 100 parts by weight of the silicate mineral filler.

6. The method of claim 1, wherein the water in the first mixture and the silicate mineral filler in the first mixture are provided by a water treated silicate mineral filler having a silicate mineral filler to water weight ratio of from 1:4 to 10:1.

7. The method of claim 1, wherein the silicate mineral filler is selected from the group consisting of clay, mica, talc, glass fiber, and silicates, and mixtures of the foregoing.

8. The method of claim 7, wherein the silicate mineral filler includes silica.

9. The method of claim 1, wherein, after said step of mixing the first mixture, the method further comprises the steps of:
cooling the first mixture;
adding a cure package to the first mixture to create a second mixture; and mixing the second mixture.

10. The method of claim 9, wherein the first mixture is created in a first mixing pass and the second mixture is created in a second mixing pass, such that the method is a two pass mixing process.

11. A silica filled rubber made by a process comprising the steps of:
adding a polymer base, silicate mineral filler, water, and silicate mineral coupling agent to a mixer to create a first mixture, wherein the silicate mineral to water weight ratio is from 1:4 to 10:1; and
mixing the first mixture to a target temperature suitable for initiating coupling of the silicate mineral filler to the polymer base.

12. The method of claim 11, wherein, after said step of mixing the first mixture, the method further comprises the steps of:
cooling the first mixture;
adding a cure package to the first mixture to create a second mixture; and mixing the second mixture.

13. The method of claim 12, wherein the first mixture is created in a first mixing pass and the second mixture is created in a second mixing pass, such that the method is a two pass mixing process.

14. A water treated silicate mineral filler comprising:
a silicate mineral filler and water, wherein the silicate mineral filler to water weight ratio is from 1:4 to 10:1
